(19) United States
(12) Patent Application Publication
(10) Pub. No.: US 2011/0145695 A1
(43) Pub. Date: Jun. 16, 2011

(54) WEB PAGE CONVERSION SYSTEM

(75) Inventor: Yuko MATSUI, Tokyo (JP)

(73) Assignee: FUJIFILM Corporation, Tokyo (JP)

(21) Appl. No.: 12/952,858

(22) Filed: Nov. 23, 2010

(30) Foreign Application Priority Data
Dec. 11, 2009 (JP) 2009-281214

(51) Int. Cl. G06F 17/00

(52) U.S. Cl. 715/234

(57) ABSTRACT

Efficiency of user operation is improved. To achieve this, a web page conforming to a request from a mobile telephone is converted to a web page image represented as one frame of an image. An image file representing the web page image is transmitted to the mobile telephone. Displayed on the display screen of the mobile telephone are image portions displayed in accordance with a sequence in which the user of the web page image applies commands. The user is capable of applying commands in regular order without moving the image in order to display a desired image portion on the display screen.

### BACKGROUND OF THE INVENTION

1. Field of the Invention

This invention relates to a web page conversion system, a web page conversion server, a method of controlling the operation of this server and a program for controlling operation of the server.

2. Description of the Related Art

Thin client systems have become the focus of attention owing to great strides in communication technology and improvements in security. For example, there are techniques whereby a server is made to run application software and an operating system, etc., and a client terminal is allowed to access the server so that the client terminal can be operated just as if it were running the application software and operating system without actually doing so (see the specifications of Japanese Patent Application Laid-Open Nos. 2003-323402 and 2003-330728), and a technique whereby a conversion can be made to a landscape-type display in a case where a document having a large number of characters is presented on a portrait-type display screen of a client terminal (see the specification of Japanese Patent Application Laid-Open No. 9-237074).

Further, in a case where a web page is viewed on a mobile telephone, there are instances where the display screen of the mobile telephone is small and difficult to view. If the web page is enlarged in size in order to facilitate viewing, the web page must be scrolled in order to display a desired portion of the page. If a large amount of scrolling is necessary, the user can find this inconvenient owing to the time and effort involved in such scrolling.

### SUMMARY OF THE INVENTION

An object of the present invention is to reduce laborious scrolling of a web page while facilitating viewing of the web page.

The present invention provides a web page data conversion system comprising a web page data conversion server and a mobile telephone having a display device.

The web page conversion server includes: a web page request receiving device (web page request receiving means) for receiving a web page request transmitted from the mobile telephone; a web page request transmitting device (web page request transmitting means) for transmitting the web page request, which has been received by the web page request receiving device, to a web page server storing web page content representing a web page requested by this web page request and including a plurality of user interface areas that accept commands from the user of the mobile telephone; a web page content receiving device (web page content receiving means) for receiving the web page content transmitted from the web page server in response to transmission of the web page request to the web server by the web page request transmitting device; a web page image generating device (web page data generating means) for generating one frame of a web page image from the web page content received by the web page content receiving device; a first user interface area deciding device (first user interface area deciding means) for deciding, from among the plurality of user interface areas included in the web page image generated by the web page image generating device, and based upon a command sequence history of commands that have been applied to the plurality of user interface areas, a user interface area expected to be one to which the user of the mobile telephone will apply a command; and a first transmitting device (first transmitting means) for transmitting first user interface area specifying data, which specifies the user interface area decided by the first user interface area deciding device, and a web page image file representing the web page image generated by the web page image generating device, to the mobile telephone.

The mobile telephone includes: a display control device (display control means), responsive to receipt of the first user interface area specifying data and web page image file transmitted from the first transmitting device of the web page data conversion server, for controlling the display unit in such a manner that an image portion, from within the web page image represented by the web page image file and which includes a user interface area specified by the first user interface area specifying data, is displayed on a display screen; a command device (command means) for applying a command to any user interface area among the plurality of user interface areas included in the web page image; and a second transmitting device (second transmitting means) for transmitting second user interface area specifying data, which specifies the user interface area to which a command has been applied by the command device, and data representing command contents of the command applied by the command device, to the web page data conversion server.

The present invention also provides a web page conversion server constituting the above-described web page conversion system.

The present invention further provides an operation control method suited to the above-described web page conversion server. Specifically, the present invention provides a method of controlling operation of a web page conversion server comprising the steps of: receiving a web page request transmitted from a mobile telephone; transmitting the received web page request to a web page server storing web page content representing a web page requested by this web page request and including a plurality of user interface areas that accept commands from the user of the mobile telephone; receiving the web page content transmitted from the web page server in response to transmission of the web page request to the web server; generating one frame of a web page image from the received web page content; deciding, from among the plurality of user interface areas included in the generated web page image, and based upon a command sequence history of commands that have been applied to the plurality of user interface areas, a user interface area expected to be one to which the user of the mobile telephone will apply a command; and transmitting first user interface area specifying data, which specifies the decided user interface area, and a web page image file representing the generated web page image, to the mobile telephone.

The present invention further provides a recording medium storing an operation control program suited to the above-described method of controlling operation of a web page conversion server. The present invention may provide this program.

In accordance with the present invention, web page content representing a web page conforming to a web page request transmitted from a mobile telephone is transmitted from a web page server to a web page conversion server. In the web page conversion server, one frame of a web page image is generated from the web page content. From among a plurality of user interface areas included in the web page image, a user interface area expected to be one to which the user of the mobile telephone will apply a command is decided in accordance with a command acceptance sequence. User interface area specifying data, which specifies the user interface area decided, and a web page image file are transmitted to the mobile telephone.

When the user interface area specifying data and the web page image file are received by the mobile telephone, an image portion which is within the web page image, and which includes a user interface area specified by the first user interface area specifying data, is displayed on a display screen of the mobile telephone. If a command is to be applied to the user interface area included in the image portion being displayed on the display screen, then the command is applied from a command device. Since a user interface area to which the user often applies a command will be displayed on the display screen, it is unnecessary to perform scrolling in order to display this user interface area to which a command will be applied. The time and effort involved in scrolling by the user can thus be curtailed. If a command is to be applied to another user interface area, then scrolling is performed. By performing scrolling, the other user interface area to which the command will be applied will be displayed on the display screen. If a command is applied to the user interface area by the user of the mobile telephone, second user interface area specifying data specifying this user interface area to which this command has been applied and data representing the contents of the command are transmitted from the mobile telephone to the web page conversion server.

Preferably, the web page conversion server further includes an updating device (updating means) for updating the command sequence history using a command to a user interface area represented by the second user interface area specifying data transmitted from the second transmitting device of the mobile telephone. In this case, in response to receipt of the data representing the command contents of the command transmitted from the second transmitting device of the mobile telephone, the web page image generating device would generate a web page image that reflects the command contents represented by the data representing the command contents. From among the plurality of user interface areas included in the generated web page image, a user interface area expected to be one to which the user will apply a command next is decided and the first user interface area specifying data specifying this decided user interface area is transmitted from the web page conversion server to the mobile telephone. With regard to an image portion that is displayed and that includes a user interface area to which the user should apply a command next, the user need no longer perform scrolling in a case where a command is applied to this user interface area of this image portion.

In a case where a web page image file has already been transmitted to the mobile telephone, the first transmitting device, rather than transmit the web page image file again, need only transmit the first user interface area specifying data that specifies the user interface area decided by the first user interface area deciding device. Further, the mobile telephone may be provided with a second display control device (second display control means), responsive to a scroll command, for controlling the display unit so as to display an image portion which is within the web page image and which is not being displayed on the display screen.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a front view of a mobile telephone;

FIG. 2 illustrates a mobile telephone and a personal computer;

FIG. 3 illustrates an overview of a web page viewing system;

FIG. 4 is a block diagram illustrating the electrical configuration of a mobile telephone;

FIG. 5 is a block diagram illustrating the electrical configuration of a relay server;

FIG. 6 is an example of a web page;

FIG. 7 is an example of an HTML document;

FIG. 8 is an example of command sequence history table;

FIG. 9 is a block diagram illustrating the electrical configuration of a web server;

FIGS. 10 and 11 are flowcharts illustrating processing executed by a web page viewing system;

FIG. 12 illustrates an example of metadata;

FIG. 13 is a flowchart illustrating mobile telephone operation/processing;

FIG. 14 illustrates an example a web page image;

FIGS. 15 to 20 show examples of image portions displayed on a mobile telephone; and

FIG. 21 illustrates an example of metadata.

### DESCRIPTION OF THE PREFERRED EMBODIMENT

A preferred embodiment of the present invention will be described with reference to the drawings.

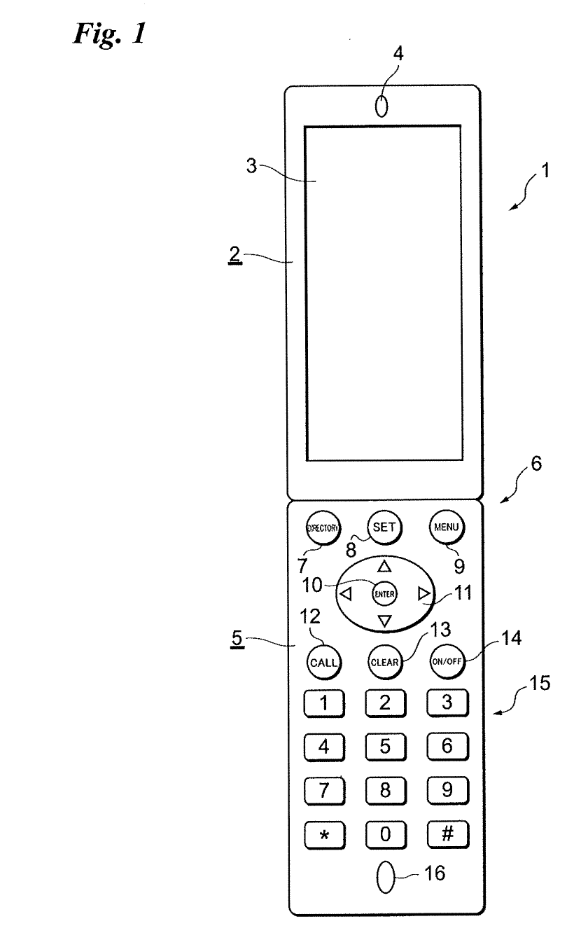

FIG. 1 is a front view of a mobile telephone 1. The mobile telephone 1, which is of the clam-shall type (although it need necessarily be of the clam-shell type), has a first-half body 2 and a second-half body 5.

The upper portion of the first-half body 2 is provided with a speaker 4, and a display screen 3 is formed over the entire surface of the first-half body 2. The second-half body 5 is provided with a multi-button keypad 6. The multi-button keypad 6 includes a telephone directory button 7, a setting button 8, a menu button 9, an enter button 10, an annular button 11 on which up, down, left and right arrows have been formed, a call button 12, a clear button 13, a power source on/off button 14 and buttons 15 on which numerals 0 to 9, an asterisk symbol and a sharp symbol have been formed. A microphone 16 is formed below the keypad 6.

A browser has been installed in the mobile telephone 1. Owing to the fact that the browser has been installed in the mobile telephone 1, a web page can be displayed on the display screen 3.

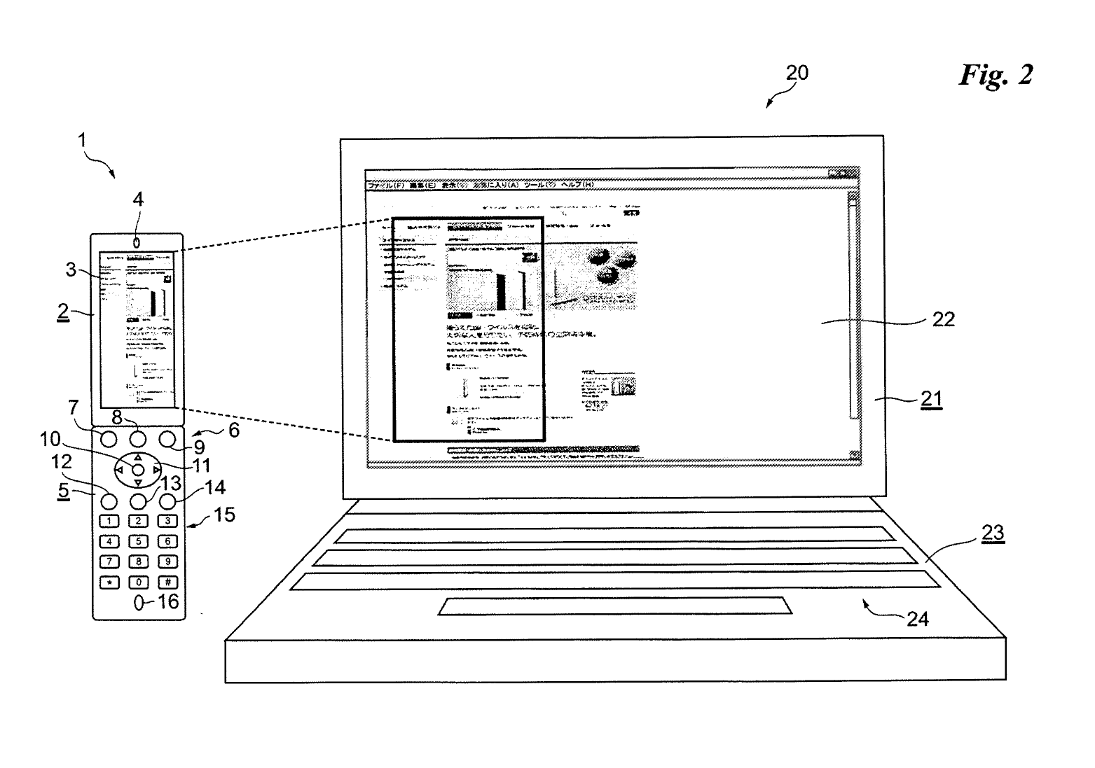

FIG. 2 illustrates the mobile telephone 1 and a personal computer 20.

The personal computer 20 includes a display section 21 and a keyboard section 23 that are freely foldable. A display screen 22 has been formed over substantially the entire surface of the display section 21. A keyboard 24 has been formed over substantially the entire surface of the keyboard section 23.

If a website is accessed using the personal computer 20, a web page is displayed on a display screen 22. Similarly, if a website is accessed using the mobile telephone 1, a web page is displayed on the display screen 3 of the mobile telephone 1.

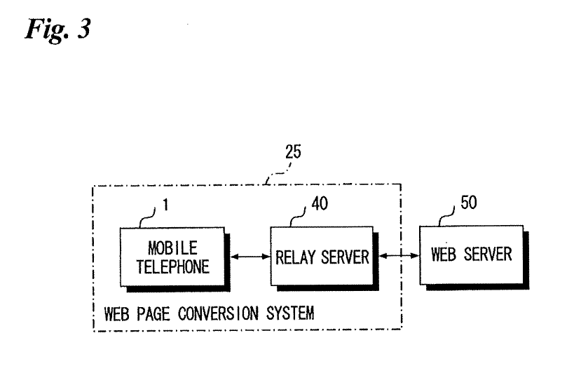

FIG. 3 illustrates an overview of a web page viewing system.

The web page viewing system includes a web page conversion system 25 and a web server 50. The web page conversion system 25 further includes the mobile telephone 1 used by a user, and a relay server (web page conversion server) 40. The relay server 40 relays communication between the mobile telephone 1 and the web server 50. The mobile telephone 1 and relay server 40, as well as the relay server 40 and web server 50, can communicate via the Internet.

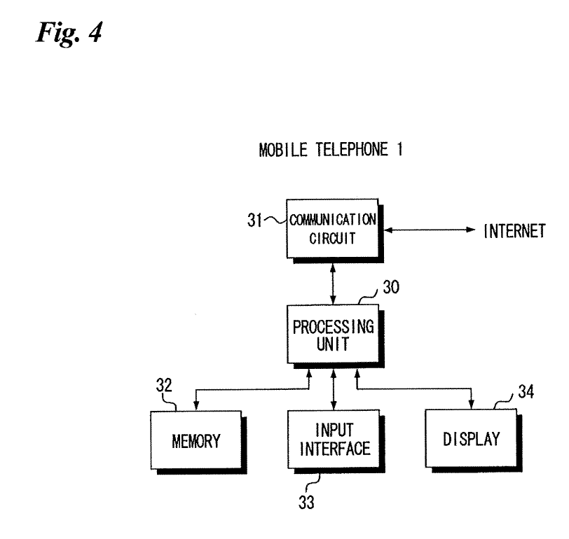

FIG. 4 is a block diagram illustrating the electrical configuration of the mobile telephone 1.

The overall operation of the mobile telephone 1 is controlled by a processing unit 30.

The mobile telephone 1 includes a communication circuit 31 for communicating with the relay server 40 via the Internet. The mobile telephone 1 further includes a memory 32 storing a browser, other programs and data, an input interface 33 for applying commands from the keypad 6 to the processing unit 30, and a display unit 34. Although the mobile telephone 1 also has a conversation function, the conversation-related circuitry is not shown.

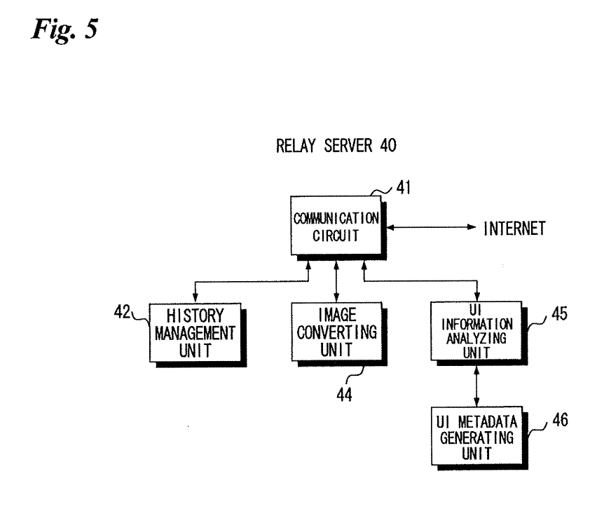

FIG. 5 is a block diagram illustrating the electrical configuration of the relay server 40.

The relay server 40 includes a communication circuit 41 for communicating with the mobile telephone 1 and the web server 50 via the Internet.

The relay server 40 includes an image converting unit 44. On the basis of web page content (a web page content file) that has been transmitted from the web server 50 via the communication circuit 41, the image converting unit 44 generates a web page image file representing a web page, which is displayed by the web page content, as one frame of an image. Although the image file is generated at a predetermined resolution, the image converting unit 44 may generate an image having a resolution that conforms to the contents of the web page content file and the resolution of the display screen 3 of the mobile telephone 1.

The relay server 40 further includes a UI (user interface) information analyzing unit 45 and a UI metadata generating unit 46. The UI information analyzing unit 45 extracts UI information contained in the web content file. The UI information represents a user interface area, such as an input area or radio button on the web page, for accepting a command such as an input or check from the user. The UI metadata generating unit 46 generates UI metadata representing the coordinate position of the user interface area on the web page and the contents of the input or check in the user interface area.

The relay server 40 further includes a history management unit 42. In a case where the user of the mobile telephone 1 has applied commands to a plurality of user interface areas contained in a web page image, the history management unit 42 stores a command sequence history table indicating the sequence in which the commands were applied.

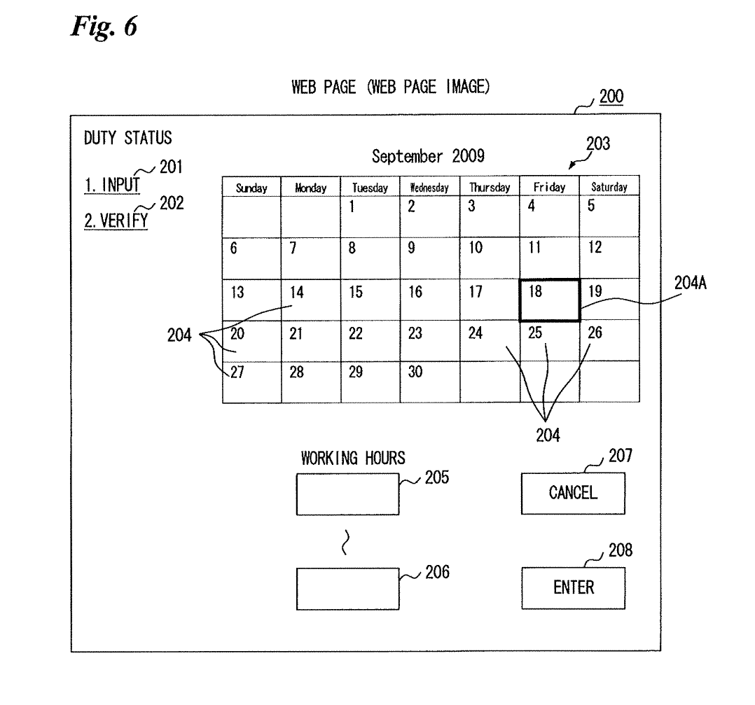

FIG. 6 illustrates an example of a web page 200.

The web page 200 is displayed based upon an HTML (HyperText Markup Language) document and enables input of information regarding duty status. A character string reading “DUTY STATUS” is displayed at the upper left of the web page 200. A character string 201 reading “1. INPUT” and a character string 202 reading “2. VERIFY” are displayed below the character string “DUTY STATUS”. The character strings 201 and 202 are clickable. A calendar 203 is displayed at the upper right of the web page 200. Days of the week are displayed at the top of the calendar 203, and days are displayed in association with the days of the week. Areas 204 in which the days are displayed are clickable. If clicked, the clicked area 204 is enclosed by a frame 204A. Displayed somewhat to the lower left of the web page 200 are a first input area 205 for inputting the starting time of working hours and a second input area 206 for inputting end time of working hours. By selecting these input areas 205 and 206, starting time and end time can be input to the input areas 205 and 206, respectively. It may also be so arranged that these times can be selected by a pull-down menu. A clickable CANCEL button area 207 and a clickable ENTER button area 208 are displayed at the lower right of the web page 200. The character strings 201, 202 and the areas 204 to 208 are the user interface areas mentioned above.

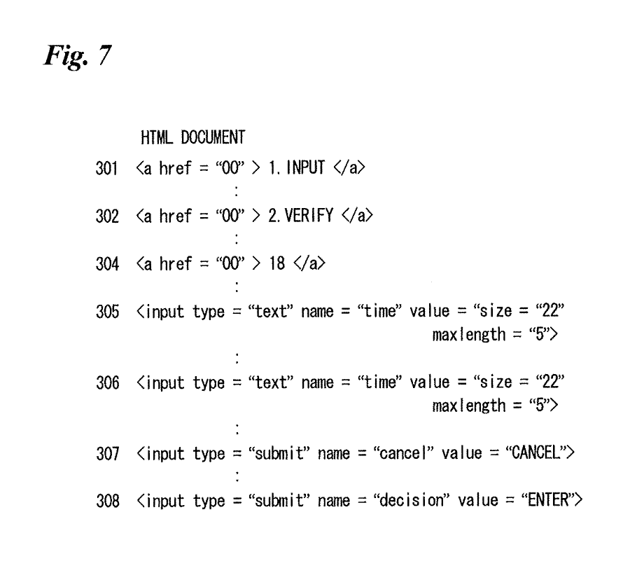

FIG. 7 illustrates part of an HTML document for displaying the web page 200 shown in FIG. 6.

A tag 301 causes the character string 201 to be displayed, and a tag 302 causes the character string 202 to be displayed. A tag 304 causes display of an area 204 to which day 18 has been assigned among the areas 204. Tags 305, 306, 307 and 308 cause the areas 205, 206, 207 and 208, respectively, to be displayed.

With reference again to FIG. 6, assume that a user is to input his or her duty status by utilizing the web page 200. Usually the user clicks the character string 201 and then clicks whichever day area 204 among the day areas 204 in calendar 203 is to receive the input. Next, the user selects the areas 205 and 206 and inputs the starting time and end times, respectively, of his or her working hours. Finally, the user clicks the ENTER area 278. The CANCEL area 207 is clicked if necessary. The sequence in which these commands are applied to the character strings 201, 202 and areas 204 to 208 is thus substantially decided. In this embodiment, the sequence in which the commands are applied is stored in a table of the history management unit 42 as the above-mentioned command sequence history.

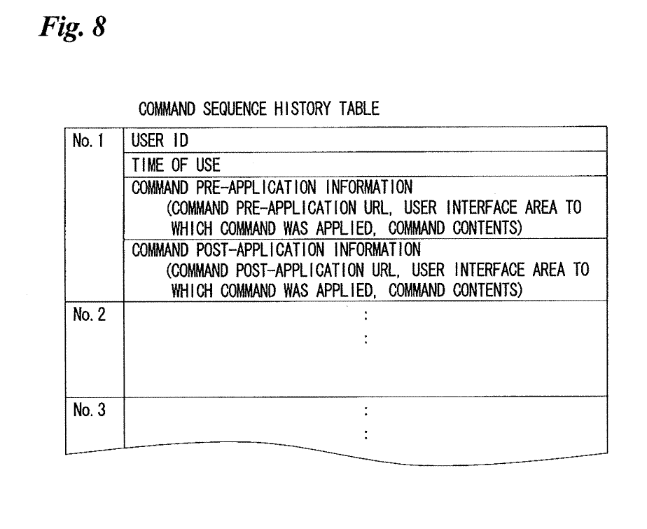

FIG. 8 illustrates an example of the command sequence history table.

A command sequence history table is defined for every web page (or for every web page image).

User ID, date of use, command pre-application information and command post-application information are stored in the command sequence history table as one set of command sequence information. User ID is an ID that identifies the user who utilized the web page. Date of use represents the date and time at which the web page was utilized. Command pre-application information includes a command pre-application URL, namely the URL (Uniform Resource Locator) of the user interface area to which a command will be applied, the user interface area to which the command was applied, and the contents of the command. The command post-application information includes a command post-application URL, which indicates the URL of a web page that includes a user interface area to which a command will be applied after a command has been applied to a user interface area, the user interface area to which the command was applied, and the contents of the command.

In the case of the example shown in FIG. 6, if an area 204 is clicked after the character string 201, a set of command sequence information is generated. In this case, the URL of the web page 200 is stored as the command pre-application URL in the command pre-application information, the identification data (UI information ID) of the character string 201 is stored in the user interface area to which the command was applied, and a click is stored as the contents of the command. Further, the URL of the web page 200 is stored as the command post-application URL in the command post-application information (since both the character string 201 and the area 204 exist on the same web page 200, the same URL is stored), the identification data of the area 204 is stored in the user interface area to which the command was applied, and a click is stored as the contents of the command.

Similarly, if the area 205 is clicked after the area 204, a set of command sequence information is generated. In this case, the command post-application information in the immediately preceding set of command sequence information is stored in the command pre-application information. Specifically, the URL of the web page 200 is stored as the command pre-application URL, the identification data of the area 204 is stored in the user interface area to which the command was applied, and a click is stored as the contents of the command. The URL of the web page 200, in which the area 205 exists, is stored as the command post-application URL in the command post-application information, the area 205 is stored in the user interface area to which the command was applied, and input of a character string is stored as the contents of the command.

In a case where a command is applied for the first time to a user interface area among a plurality of user interface areas contained in a web page, command pre-application information contains no data.

It will be appreciated that from the command pre-application information and command post-application information that has been stored in the command sequence history table, the particular sequence in which the user applied commands to the user interface areas can be determined.

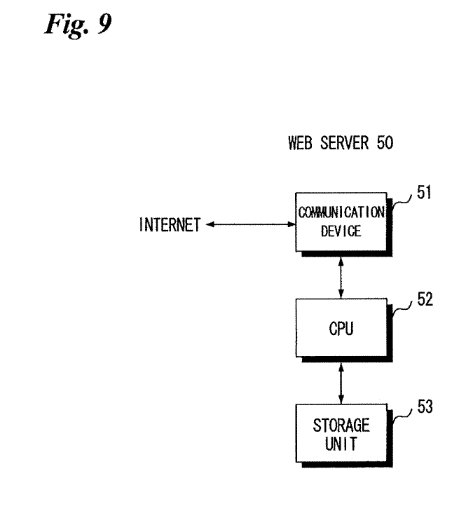

FIG. 9 is a block diagram illustrating the electrical configuration of the web server 50.

The overall operation of the web server 50 is controlled by a CPU 52.

The web server 50 also includes a communication device 51 for communicating with the relay server 40 via the Internet. The web server 50 further includes a storage unit 53 for storing a number of web content files for displaying a number of web pages. A web content file conforming to a web page request transmitted from the relay server 40 is read out of the storage unit 53. The web content file read out is transmitted to the relay server 40 by the communication device 51.

In the above-described embodiment, only one mobile telephone 1 is illustrated. However, a number of mobile telephones 1 capable of communicating with the relay server 40 exist and each communicates with the relay server 40 individually. Further, a number of the web servers 50 also exist and the relay server 40 is capable of communicating with each of the web servers 50. Regardless of which one of the mobile telephones 1 accesses which web server 50, communication is carried out via the relay server 40.

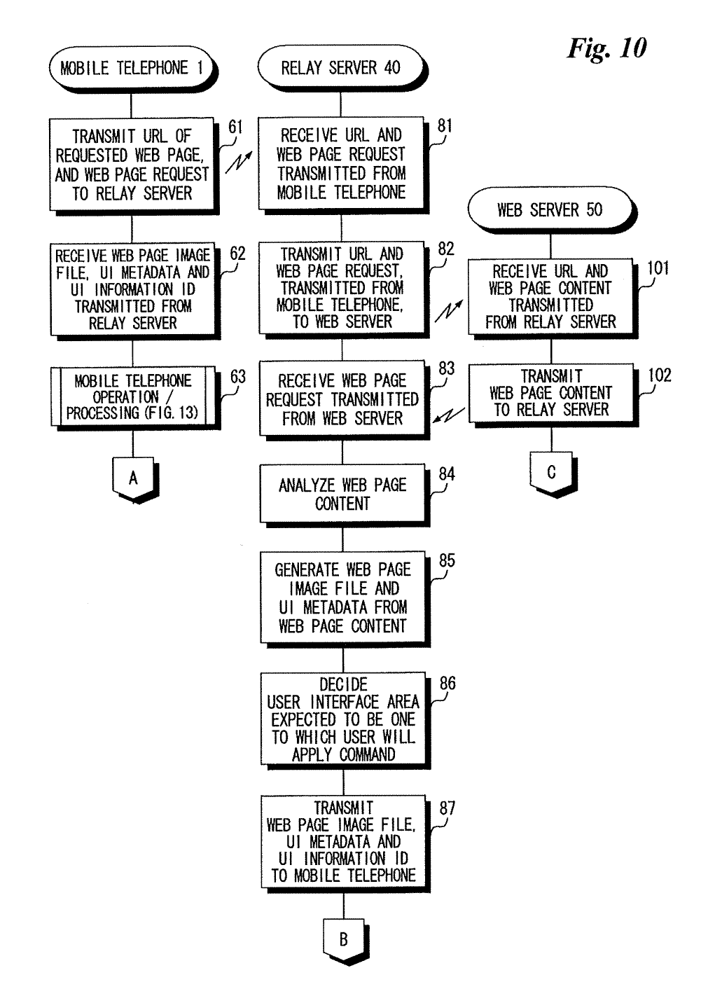

FIGS. 10 and 11 are flowcharts illustrating processing executed by the web page viewing system.

The user launches the browser that has been installed in the mobile telephone 1 and, using the keypad 15 of the mobile telephone 1, inputs the URL of the web page desired to be viewed. Rather than inputting the character string of the URL directly, the user may select the URL from among URLs that have been stored in the memory 32 of the mobile telephone 1. If the enter button 10 is pressed after the URL is input, the data representing the entered URL and a web page request are transmitted to the relay server 40 (step 61 in FIG. 10).

The URL data and the web page request transmitted from the mobile telephone 1 are received by the relay server 40 (step 81 in FIG. 10), whereupon the URL data and the web page request transmitted from the mobile telephone 1 are transmitted from the relay server 40 to the web server 50 (step 82 in FIG. 10).

When the URL data and the web page request transmitted from the relay server 40 are received by the web server 50 (step 101 in FIG. 10), a web page file that has been stored at the storage location of the URL specified by the received URL data is read from the storage unit 53. The read web content file is transmitted from the web server 50 to the relay server 40 (step 102 in FIG. 10).

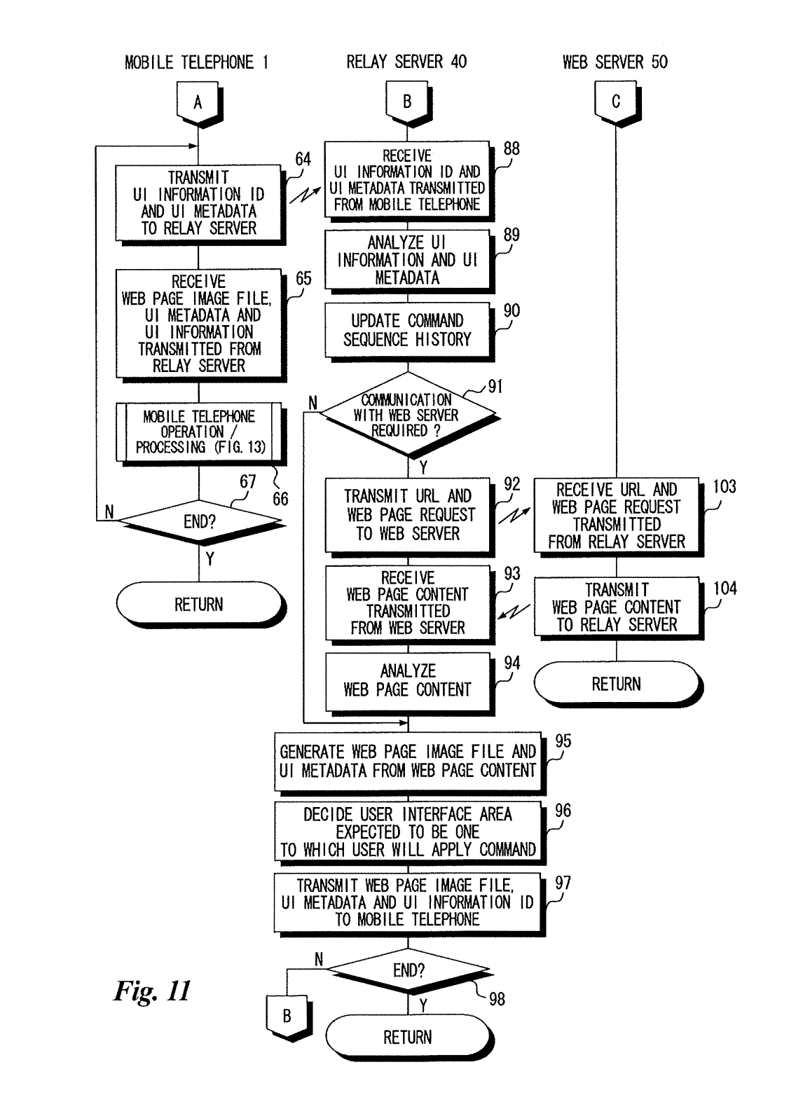

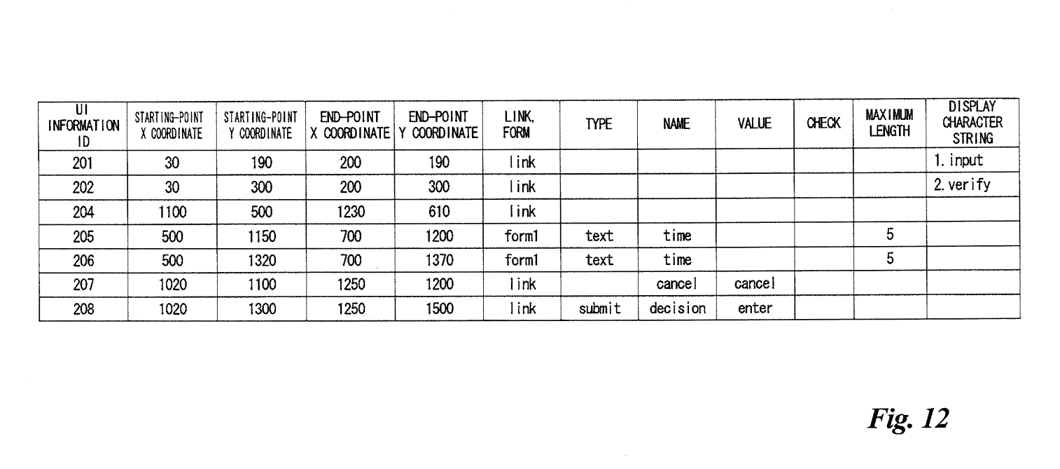

The relay server 40 receives the web content file transmitted from the web server 50 (step 83 in FIG. 10). The received web content file is analyzed and the UI information (see FIG. 12) extracted by the UI information analyzing unit 45 (step 84 in FIG. 10). The method of analyzing the web content file is not particularly limited and use may be made of a well-known method of parsing an HTML file, which is contained in the web content file, and extracting tags.

Next, the relay server 40 generates an image file for displaying a web page image representing, as one frame of an image, the web page represented by the web page content file (step 85 in FIG. 10). It is possible to generate this image file by executing processing in the image converting unit 44 for converting the web content file to an image file. Further, the UI information analyzing unit 45 generates UI metadata based upon the result of analysis (step 85 in FIG. 10).

The UI information analyzing unit 45 extracts UI information such as link tags and input forms from the HTML document shown in FIG. 7 and calculates the coordinate positions of the user interface areas on the web page of FIG. 6. For example, link tags 301, 302 and 303, text input section tags 305 and 306, and radio button tags 307 and 308 have been described in the HTML document shown in FIG. 7. The user interface areas 201, 202 and 204 to 208 are formed by these tags 301, 302 and 304 to 308, respectively, as described above.

The UI information analyzing unit 45 extracts the user interface areas 201, 202 and 204 to 208 by extracting the tags 301, 302 and 304 to 308, respectively, from the HTML document. Further, the UI information analyzing unit 45 acquires the XY coordinate values (coordinate values corresponding to the upper left and lower right) of the beginning and end of each of these user interface areas. The method of acquiring the coordinate values is not particularly limited. For example, a method of storing the coordinate values during image rendering and then acquiring the values from a browser may be used.

Each user interface area thus extracted and the position information of each area are correlated together with a respective UI information ID, which identifies the user interface area, and are stored in a storage unit (not shown) of the relay server 40 as UI metadata. Here it is assumed that the UI information ID uses the symbols 201, 202 and 204 to 208 identical with those of the respective user interface areas.

FIG. 12 is an example of UI metadata that has been stored.

For every item of UI information specified by a UI information ID, the UI metadata contains a starting-point X coordinate, starting-point Y coordinate, end-point X coordinate and end-point Y coordinate of the UI information; information indicating whether the user interface area is a link or form; the type of user interface area; the name of the user interface area; the value of the user interface area; a check of the user interface area; the maximum value of the user interface area; and a display character string.

The web page image is formed to have user interface areas corresponding to the character strings 201, 202 and 204 to 208, in a manner similar to that of the web page shown in FIG. 6. The web page shown in FIG. 6, therefore, will be treated as the web page image as necessary. However, the web page image is different from that of web page 200 shown in FIG. 6 in that text cannot be input directly and cannot be clicked.

With reference again to FIG. 10, from among the plurality of user interface areas included in the web page image, a user interface area expected to be one to which the user will apply a command (an initial command) is decided by referring to the above-described command sequence history table (step 86 in FIG. 10). For example, in the case of the web page image 200 shown in FIG. 6, the user interface area to which a command will be applied by a user who has accessed the web page image 200 the first time is expected to be the user interface area 201, as mentioned earlier, and therefore the UI information ID (first user interface area specifying data) identifying the user interface area 201 is transmitted from the relay server 40 to the mobile telephone 1 (step 87 in FIG. 10). Further, the web page image file and UI metadata are also transmitted from the relay server 40 to the mobile telephone 1 along with the UI information ID (step 87). The web page content file is stored in the relay server 40 in the storage device thereof in correlation with the mobile telephone 1 to which the transmission was made and the generated UI metadata.

The mobile telephone 1 receives the UI metadata, web page image file and user interface area specifying data transmitted from the relay server 40 (step 62 in FIG. 10). Upon receiving the UI metadata, web page image file and user interface area specifying data, the mobile telephone 1 displays the web page image, which is represented by the received image file, on the display screen 3. While viewing the web page image displayed on the display screen 3, the user operates the keypad (mobile telephone operation/processing; step 63 in FIG. 10). The details of the mobile telephone operation/processing will be described later.

In accordance with this operation of mobile telephone 1, the UI metadata is rewritten and the UI information ID and rewritten UI data are transmitted from the mobile telephone 1 to the relay server 40 (step 64 in FIG. 11).

The UI metadata and UI information ID transmitted from the mobile telephone 1 are received by the relay server 40 (step 88 in FIG. 11).

The UI information analyzing unit 45 analyzes the received UI metadata and executed UI information ID and performs analysis to determine which user interface area in the UI metadata was executed (step 89 in FIG. 11). If all of the information of one set of command sequence history information in the command sequence history table has been filled in, new command sequence history information is stored in the user ID, date of use and command pre-application information. The user interface area to which the command has been applied is understood from the received UI information ID, and the command sequence history table is updated (step 90 in FIG. 11). The command pre-application URL is the same as the URL of the web page that has been stored in the relay server 40, and the command contents are understood from the UI meta data. If the user ID, date of use and command pre-application information in one set of command sequence history information have been filled in but the command post-application information has not, then the UI information ID that has been transmitted from the mobile telephone 1 is that concerning command post-application information, and the command post-application URL, the user interface area to which the command was applied and the command contents are stored in the command sequence history table.

The UI information analyzing unit 45 determines whether communication with the web server 50 is necessary (step 91 in FIG. 11) based upon the executed user interface area (step 91 in FIG. 11). For example, if a link button is clicked and it is necessary to move to another web page, then it is determined that communication with the web server 50 is necessary.

In a case where the user interface area that has been executed is a user interface area requiring communication with the web server 50 (“YES” at step 91 in FIG. 11), the relay server 40 acquires the URL of the destination from the web page content that has been stored in the storage unit of the relay server 40 and transmits data representing the acquired URL and a web page request to the applicable web server 50 (step 92 in FIG. 11).

Upon receiving the URL data and web page request transmitted from the relay server 40 (step 103 in FIG. 11), the web server 50 reads out the web page content file that has been stored at the URL specified by this URL data. The web page content file read out is transmitted from the web server 50 to the relay server 40 (step 104 in FIG. 11).

When the web page content file transmitted from the web server 50 is received by the relay server 40 (step 93 in FIG. 11), the web page content file is analyzed in the UI information analyzing unit 45 (step 94 in FIG. 11).

The UI information analyzing unit 45 generates the UI metadata of the destination based upon the result of analysis, and the image converting unit 44 generates an image file anew from the web page content file at the destination (step 95 in FIG. 11). A user interface area expected to be one to which the user will apply a command the first time is decided also in the new web page represented by the newly generated web page image file (step 96). The generated new web page image file, UI metadata and the UI information ID (second user interface area specifying data) specifying the decided user interface area are transmitted from the relay server 40 to the mobile telephone 1 (step 97 in FIG. 11). If this processing is not exited, then the processing from step 88 onward is repeated (step 98 in FIG. 11).

The mobile telephone 1 receives the web page image file, UI metadata and UI information ID transmitted from the relay server 40 (step 65 in FIG. 11) and displays the web page image, which is represented by the image file, on the display screen 3 as the web page image of the destination. The mobile telephone is operated using the web page image displayed (step 66 in FIG. 11). If this processing is not exited, then the processing from step 64 onward is repeated (step 67 in FIG. 11).

If it is determined that the user interface area executed in the mobile telephone 1 is a user interface area not requiring communication with the web server 50 (“NO” at step 91 in FIG. 10.), then control proceeds to step 95. The web page content file related to the rewritten UI metadata is read out of the storage unit of the relay server 40 and a new web page image file is generated based upon the rewritten UI metadata (step 95 in FIG. 11). Rather than generate a new web page image file, rewriting may be performed only with regard to the portion of the web page image that requires rewriting.

A user interface area which is highly likely to be the next to which the user of the mobile telephone 1 applies a command following the user interface area to which a command was applied by the user is decided from the command sequence history table (step 96 in FIG. 11).

In FIG. 6, if the user interface area to which the command was applied by the user is the character string 201, then it is decided that the user interface area which is highly likely to be next to which a command is applied following the character string 201 is the user interface area 204.

With reference again to FIG. 11, the new web page image file, UI metadata and the UI information ID specifying the decided user interface area are transmitted from the relay server 40 to the mobile telephone 1 (step 97 in FIG. 11).

The mobile telephone 1 receives the web page image file, UI metadata and UI information ID transmitted from the relay server 40 (step 65 in FIG. 11) and displays the web page image represented by the image file on the display screen 3. The mobile telephone is operated using the web page image displayed (step 67 in FIG. 11).

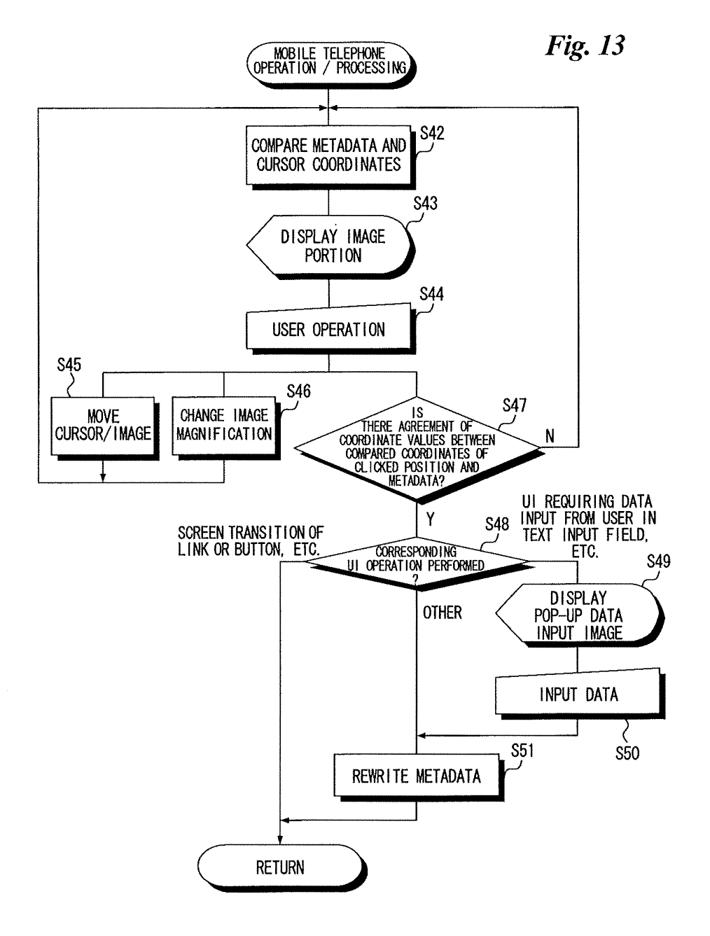

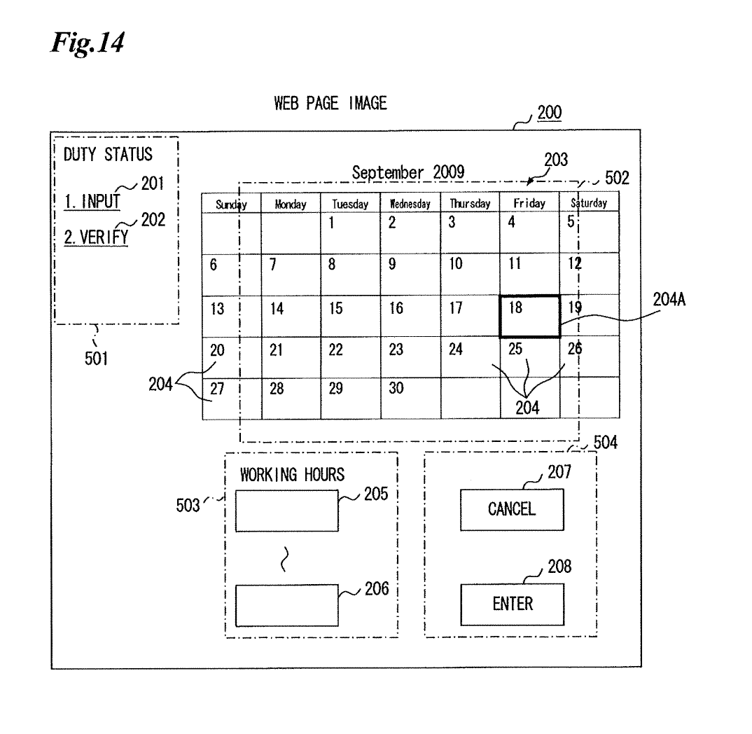

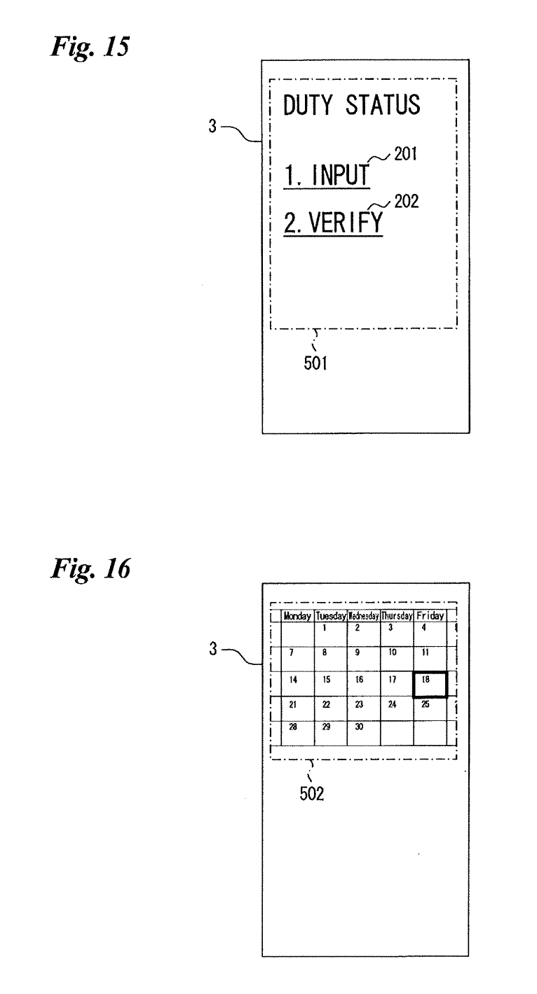

FIG. 13 is a flowchart illustrating processing (the processing of step 63 in FIG. 10 and the processing of step 66 in FIG. 11) executed in the mobile telephone 1 using the web page image file, UI metadata and UI information ID transmitted from the relay server 40. FIG. 14 is an example of a web page image file represented by the web page image file. FIGS. 15 to 20 are examples of image displayed on the display screen 3 of mobile telephone 1.

In FIG. 14, it is assumed that a user who has accessed the web page image 200 often applies commands to user interface areas in the order of the user interface areas 201, 204, 205, 206 and 208. It goes without saying that this sequence is known from the command sequence history table.

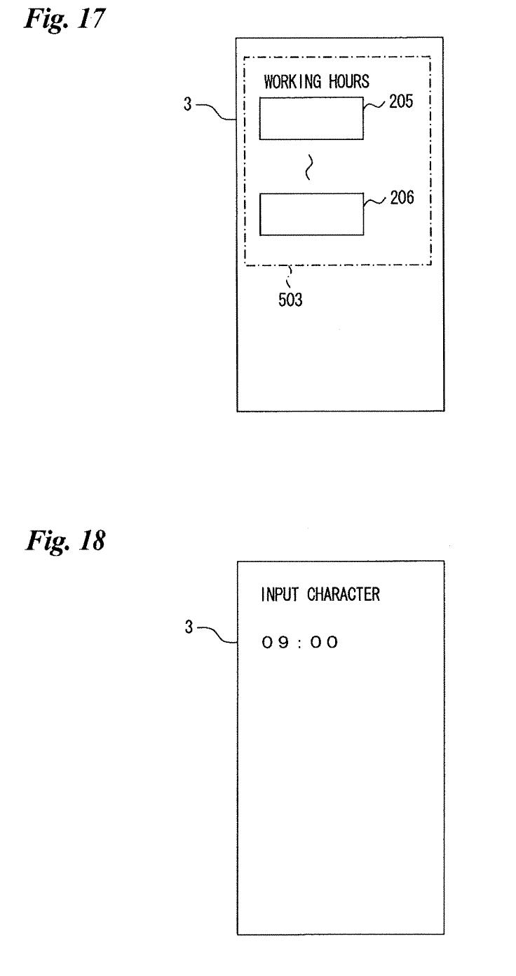

In this embodiment, image portions of the web page image 200 are displayed on the display screen 3 of mobile telephone 1 in accordance with the sequence in which commands are applied by the user. For example, an image portion 501 that includes the user interface area 201 is displayed first on the display screen 3 (see FIG. 15), next an image portion 502 that includes the user interface area 204 is displayed on the display screen 3 (see FIG. 16), next an image portion 503 that includes the user interface areas 205 and 206 is displayed on the display screen 3 (see FIG. 17), and then an image portion 504 that contains the user interface area 208 is displayed on the display screen 3 (see FIG. 20). Although the display screen 3 of mobile telephone 1 is comparatively small, a portion of the web page image 200 is displayed on the display screen 3 instead of the entire web page image 200. As a result, it becomes easier for the user to apply commands. In particular, since the sequence in which image portions are displayed on the display screen 3 of the mobile telephone 1 corresponds to the sequence in which the user would apply commands, the number of times the user changes over (scrolls) the image to be displayed is reduced.

In FIG. 13, when the mobile telephone 1 receives web page image file, UI metadata and UI information ID, the mobile telephone 1 uses the processing unit 30 to compare the position coordinates of each user interface area contained in the UI metadata and a cursor (or simple frame) that is displayed on the display screen 3 (step S42). The image portion that includes the user interface area is displayed on the display screen 3 based upon the result of comparison (step S43).

For example, when the position coordinates of the cursor overlap the position coordinates of a user interface area, a mark is appended to the portion at the position of the applicable user interface area and the user is made aware of the fact that the user interface area is selectable. Further, the portion may be underlined or enclosed by a square. If the cursor is situated within a rectangular zone in which the XY coordinates of each user interface area recorded in the UI metadata are adopted as the diagonal, then the position coordinates of the user interface area and the position coordinates of the cursor are regarded as overlapping. Further, rather than in a case where there is overlap, such a display may be performed at all times with respect to the position of the displayed user interface area on the image. Conversely, the cursor may be displayed upon changing the color or shape thereof when the cursor position coordinates overlap the position coordinates of the user interface area.

Within the web page image represented by the received web page image file, the image portion that includes the user interface area specified by the received UI information ID is displayed on the display screen 3 of the mobile telephone 1 (step S43). As illustrated in FIG. 15, the image portion first displayed on the display screen 3 of the mobile telephone 1 after the web page request has been transmitted from the mobile telephone 1 to the relay server 40, as described above, is the image portion 501 containing the user interface area 201 which is often the first to which the user applies a command. Cursor C is being displayed in the image portion 501, as described above.

When the user performs an operation using the keypad 15 (step S44), the display on the display screen 3 changes in accordance with the operation performed.

If the enter button 10 is pressed, the UI information ID identifying the user interface area 201 at which the cursor C is situated and the UI metadata indicating that the user interface area 201 has been designated are transmitted from the mobile telephone 1 to the relay server 40, as described earlier. As a result, the link destination of the user interface area 201 is displayed on the display screen 3. In a case where an up, down, left, right movement operation is performed using the button 11, the cursor is moved in accordance with this operation (step S45). If an operation for downward movement is performed by the button 11 in a case where the cursor C is situated at the user interface area 201, then the cursor C moves to the position of the user interface area 202 below the user interface area 201, as shown in FIG. 15. The image portion 501 being displayed on the display screen 3 is the portion at the upper left of the web page image 200, as will be understood from FIG. 14. Since the web page image file representing the entire web page image 200 has been transmitted to the mobile telephone 1, portions other than the image portion 501 within the web page image can also be displayed on the display screen 3 of the mobile telephone 1. If an operation for rightward movement is performed by the button 11 in a case where image portion 501 is being displayed on the display screen 3, then the portion on the right side of the image portion 501 is displayed on the display screen 3, as shown in FIG. 15. Similarly, if, after the cursor C is positioned at the location of the user interface area 202 by performing an operation for downward movement by button 11 in a case where image portion 501 is being displayed on the display screen 3, an operation for further downward movement is performed using button 11, then the portion on the lower side of the image portion 501 is displayed within the web page image 200 on the display screen 3.

With reference again to FIG. 13, in a case where a size reducing/enlarging operation has been performed, all or part of the web page image 200 is displayed upon being changed to a magnification conforming to the operation (step S46).

If the enter button 10 has been pressed, whether the cursor position and position of the user interface area on the image overlap is determined based upon the result of the comparison performed at step S42 (step S47).

If the cursor position does not overlap the position of the user interface area on the image, then the pressing of the enter button 10 is invalidated (“NO” at step S47).

If the cursor position overlaps the position of the user interface area on the image (“YES” at step S47), then, based upon the UI metadata, the processing unit 30 discriminates the type of the user interface area situated at the position of overlap with the cursor position (step S48).

Three types of user interface areas are conceivable, namely a user interface area, such as an input in a text input field, requiring a user input; a user interface area, such as a check box or radio button, not accompanied by a screen transition and not requiring a data input; and a user interface area, such as a link or button, accompanied by a screen transition.

If the enter button 10 is pressed, as described above, as a UI operation in a case where the cursor C is present in the user interface area 201, as illustrated in FIG. 15, then the UI information ID, which identifies the user interface area on which the cursor was situated when the enter button 10 was pressed, and the UI metadata are transmitted from the mobile telephone 1 to the relay server 40, as described above. When this takes place, the relay server 40 updates the command sequence history table based upon the UI information ID and UI metadata in the manner described above.

Further, the web page image file and the UI information ID for which the image portion 502 is displayed are transmitted from the relay server 40 to the mobile telephone 1. The image portion 502, which includes the user interface area 204 that would be operated on next by the user following the user interface area 201, is displayed on the display screen 3 of the mobile telephone 1, as shown in FIG. 16.

If the cursor C is positioned on the user interface area 204 and the enter button 10 is pressed, then the image portion 503, which includes the user interface area 205 that would be operated on next by the user following the user interface area 204, is displayed on the display screen 3 of the mobile telephone 1, as shown in FIG. 17. The user interface area 205 requires a text input from the user. Thus, if the type of user interface area present at the cursor position is a user interface area such as a text input field requiring a data input from the user, first a data input screen is displayed on the display screen 3 as by a pop-up (step S49).

FIG. 18 is an example of a data input screen.

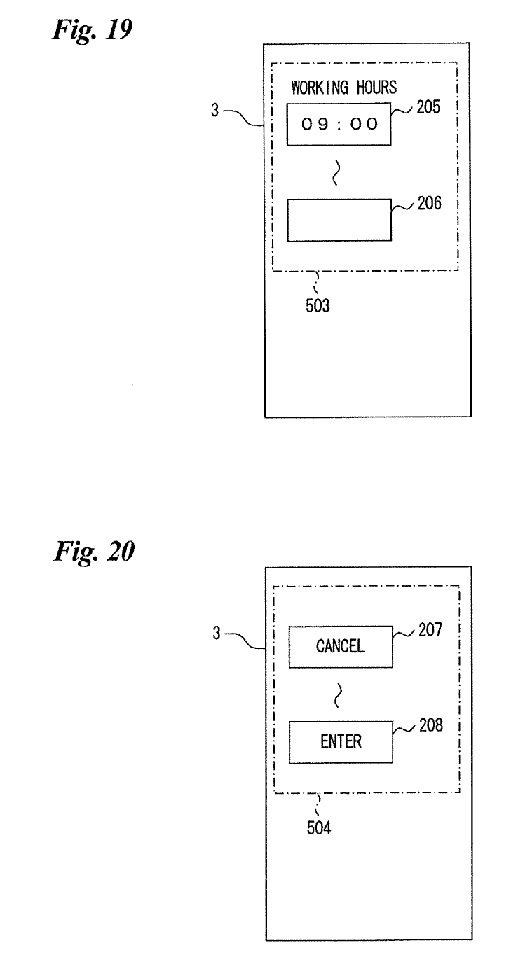

When the data input screen is displayed (step S49), the user performs the required data input on this input screen 505 using the keypad 6 (step S50), as described above. In accordance with the user input, the processing unit 30 rewrites the UI metadata that has been stored in the memory 32 (step S51). The rewritten UI metadata is transmitted together with the rewritten UI information ID to the relay server 40 via the communication circuit 31 (step S52). When this is done, the web page image file representing the web page image that includes the image portion 503 in which the text entered by the user is being displayed in the first input area 205, the UI information ID and the UI metadata are transmitted from the relay server 40 to the mobile telephone 1. The image portion 503, which includes the user interface area 205 specified by the UI information ID, is displayed on the display screen 3 of the mobile telephone 1, as illustrated in FIG. 19. Similarly, the user of the mobile telephone 1 inputs text in the user interface area 206 also and the entered text is displayed.

If the enter button is pressed after text is input to the user interface area 206, the image portion 504 is displayed on the display screen 3 of the mobile telephone 1 in a manner similar to that described above. When the user finishes operating the mobile telephone 1, the user interface area 208 is indicated by the cursor and the user presses the enter button 10.

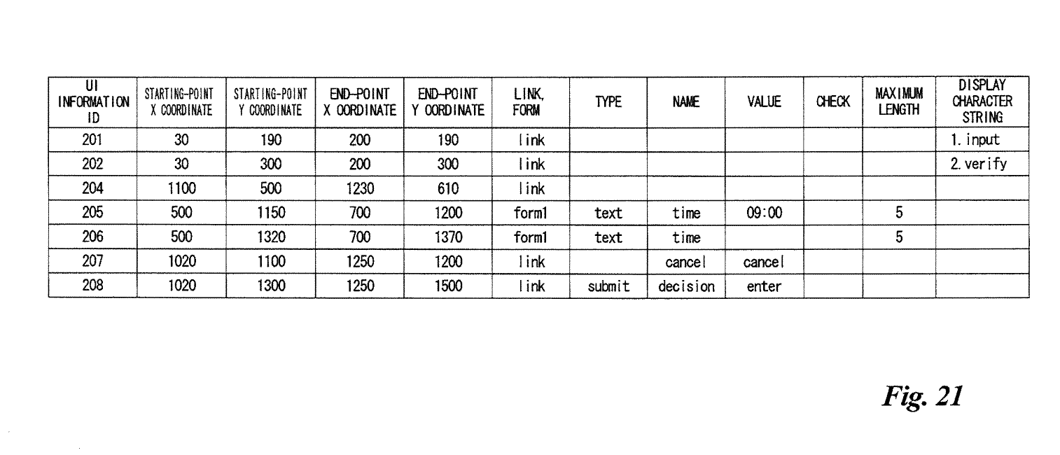

The rewriting of the UI metadata will now be described with reference primarily to FIGS. 12 and 21.

FIG. 21 is an example of metadata similar to FIG. 12. The metadata shown in FIG. 21 is that which prevails after text has been input to the user interface area 205 in the manner described above.

When text is thus input to the user interface area 205, the content of the text in which the value of the UI information ID 205 corresponding to the user interface area 205 has been input changes. In the above-described example, the text “09:00” has been input. Accordingly, the text “09:00” has been added to the value of UI information ID 205 corresponding to the user interface area 205. Metadata thus rewritten is transmitted from the mobile telephone 1 to the relay server 40, as described above.

The foregoing embodiment mentions metadata that is rewritten if text is input. However, metadata is rewritten in similar fashion also by checking of a radio button, etc., and not only by a text input.

As many apparently widely different embodiments of the present invention can be made without departing from the spirit and scope thereof, it is to be understood that the invention is not limited to the specific embodiments thereof except as defined in the appended claims.

What is claimed is:

1. A web page conversion system comprising a web page data conversion server and a mobile telephone having a display device, wherein said web page data conversion server includes:
a web page request receiving device for receiving a web page request transmitted from the mobile telephone;
a web page request transmitting device for transmitting the web page request, which has been received by said web page request receiving device, to a web page server storing web page content representing a web page requested by this web page request and including a plurality of user interface areas that accept commands from the user of said mobile telephone;
a web page content receiving device for receiving the web page content transmitted from said web page server in response to transmission of the web page request to said web server by said web page request transmitting device;
a web page image generating device for generating one frame of a web page image from the web page content received by said web page content receiving device;
a first user interface area deciding device for deciding, from among the plurality of user interface areas included in the web page image generated by said web page image generating device, and based upon a command sequence history of commands that have been applied to the plurality of user interface areas, a user interface area expected to be one to which the user of said mobile telephone will apply a command; and
a first transmitting device for transmitting first user interface area specifying data, which specifies the user interface area decided by said first user interface area deciding device, and a web page image file representing the web page image generated by said web page image generating device, to said mobile telephone; and
said mobile telephone includes:
a display control device, responsive to receipt of the first user interface area specifying data and web page image file transmitted from said first transmitting device of said web page data conversion server, for controlling the display unit in such a manner that an image portion, from within the web page image represented by the web page image file and which includes a user interface area specified by the first user interface area specifying data, is displayed on a display screen;
a command device for applying a command to any user interface area among the plurality of user interface areas included in the web page image; and
a second transmitting device for transmitting second user interface area specifying data, which specifies the user interface area to which the command has been applied by said command device, and data representing command contents of the command applied by said command device, to said web page data conversion server.

2. The system according to claim 1, wherein said web page conversion server further includes an updating device for updating the command sequence history using a command to a user interface area represented by the second user interface area specifying data transmitted from said second transmitting device of said mobile telephone; and
in response to receipt of the data representing the command contents of the command transmitted from said second transmitting device of said mobile telephone, said web page image generating device generates a web page image that reflects the command contents represented by the data representing the command contents.

3. A web page conversion server comprising:
a web page request receiving device for receiving a web page request transmitted from a mobile telephone;
a web page request transmitting device for transmitting the web page request, which has been received by said web page request receiving device, to a web page server storing web page content representing a web page requested by this web page request and including a plurality of user interface areas that accept commands from the user of the mobile telephone;
a web page content receiving device for receiving the web page content transmitted from said web page server in response to transmission of the web page request to said web page server by said web page request transmitting device;
a web page image generating device for generating one frame of a web page image from the web page content received by said web page content receiving device;
a user interface area deciding device for deciding, from among the plurality of user interface areas included in the web page image generated by said web page image generating device, and based upon a command sequence history of commands that have been applied to the plurality of user interface areas, a user interface area expected to be one to which the user of the mobile telephone will apply a command; and
a transmitting device for transmitting user interface area specifying data, which specifies the user interface area decided by said user interface area deciding device, and a web page image file representing the web page image generated by said web page image generating device, to the mobile telephone.

4. A method of controlling operation of a web page conversion server, comprising the steps of:
receiving a web page request transmitted from a mobile telephone;
transmitting the received web page request to a web page server storing web page content representing a web page requested by this web page request and including a plurality of user interface areas that accept commands from the user of the mobile telephone;
receiving the web page content transmitted from the web page server in response to transmission of the web page request to the web server;
generating one frame of a web page image from the received web page content;
deciding, from among the plurality of user interface areas included in the generated web page image, and based upon a command sequence history of commands that have been applied to the plurality of user interface areas, a user interface area expected to be one to which the user of the mobile telephone will apply a command; and
transmitting user interface area specifying data, which specifies the decided user interface area, and a web page image file representing the generated web page image, to the mobile telephone.

5. A recording medium storing a computer-readable program for controlling operation of a web page conversion server so as to:
receive a web page request transmitted from a mobile telephone;
transmit the received web page request to a web page server storing web page content representing a web page requested by this web page request and including a plurality of user interface areas that accept commands from the user of the mobile telephone;
receive the web page content transmitted from the web page server in response to transmission of the web page request to the web server;
generate one frame of a web page image from the received web page content;
decide, from among the plurality of user interface areas included in the generated web page image, and based upon a command sequence history of commands that have been applied to the plurality of user interface areas, a user interface area expected to be one to which the user of the mobile telephone will apply a command; and
transmit user interface area specifying data, which specifies the decided user interface area, and a web page image file representing the generated web page image, to the mobile telephone.
